(19) United States
(12) Patent Application Publication
(10) Pub. No.: US 2025/0367612 A1
(43) Pub. Date: Dec. 4, 2025

(54) ASYMMETRIC POLYMERIC POROUS FILTER MEMBRANES AND RELATED METHODS

(71) Applicant: ENTEGRIS, INC., Billerica, MA (US)

(72) Inventors: Kwok-Shun Cheng, Nashua, NH (US); Brian Anthony Gagnon, North Billerica, MA (US); Dongzhu Wu, Hangzhou (CN); Zachary T. Kivi, Dracut, MA (US); Nathaniel Goff, Somerville, MA (US)

(21) Appl. No.: 18/874,627

(22) PCT Filed: Jun. 15, 2023
(86) PCT No.: PCT/US2023/025431

§ 371 Date: Dec. 13, 2024

(30) Foreign Application Priority Data
Jun. 15, 2022 (CN) 202210685328.6
Jun. 15, 2022 (CN) 202221496724.6

(51) Int. Cl. B01D 71/68; B01D 67/00

(52) U.S. Cl. CPC B01D 71/68; B01D 67/0013; B01D 2323/219; B01D 2325/022

(57) ABSTRACT

Described are porous polymeric filter membranes that have a multi-asymmetric pore structure through a thickness of the membrane and to methods of making and using the porous polymeric filter membranes.

### FIELD

The following description relates to porous polymeric filter membranes that have a multi-asymmetric pore structure over a thickness of the membrane, and to methods of making and using the porous polymeric filter membranes.

### BACKGROUND

Many gaseous and liquid fluids are processed using filters to remove contaminants or impurities. Examples include air, drinking water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved or suspended molecular chemical species. Specific examples of impurity removal applications for filter membranes include their use to remove cellular residue particles, bacteria, or other organic matter from therapeutic solutions in the pharmaceutical industry, or to process ultrapure aqueous and organic solvent solutions for use in microelectronics and semiconductor processing, or for air and water purification processes.

To perform a filtration function, a filter product includes a filter membrane that is responsible for removing unwanted material from a fluid as the fluid passes through the filter. The filter membrane may, as required, be in the form of a flat sheet, which may be wound (e.g., spirally), or pleated, etc. The filter membrane may alternatively be in the form of hollow fibers. The filter membrane can be contained within a housing that includes an inlet and an outlet, so that fluid that is being filtered enters through the inlet and passes through the filter membrane before passing through the outlet.

Filter membranes can be constructed of porous polymeric films that have average pore sizes that can be selected based on the expected use of the filter, i.e., the type of filtration to be performed using the filter. Typical pore sizes are in the micron or sub-micron range, such as from about 0.001 micron to about 10 micron. Membranes with average pore size of from about 0.001 to about 0.05 micron are sometimes classified as ultrafilter membranes. Membranes with pore sizes between about 0.05 and 10 microns are sometimes classified as microporous membranes.

For commercial use, a filter membrane should be of a type that can be efficiently manufactured and assembled into a filter product. The membrane must be capable of being efficiently produced, and must have mechanical properties such as strength and flexibility that allow the filter membrane to withstand assembly into the form of a filter cartridge or other form of a filter membrane structure. In addition to mechanical properties, the membrane should have suitable chemical functionality, including stability and microstructure (pore size and morphology) for high performance filtration.

Various techniques are known for forming porous filter membranes. Example techniques include melt-extrusion (e.g., melt-casting) techniques, immersion casting (phase inversion) techniques, among others. The different techniques for forming a porous polymeric membrane may produce different membrane structures in terms of the size and distribution of pores that are formed within the membrane, i.e., different techniques produce different pore sizes and membrane structures, sometimes referred to as morphology, meaning the uniformity, non-uniformity shape, sizes, and distribution of pores within a membrane.

Examples of membrane morphologies include homogeneous (isotropic) and asymmetric (anisotropic). A membrane that has pores of substantially uniform sizes (within a range) that are uniformly distributed throughout the membrane is often referred to as isotropic, or “homogeneous.” An anisotropic (a.k.a., “asymmetric”) membrane may be considered to have a morphology in which a pore size gradient exists across the membrane. For example, a membrane may have a porous structure with relatively larger pores at one membrane surface and relatively smaller pores at an opposite membrane surface with the pore structure varying along the thickness of the membrane. The term “asymmetric” is often used interchangeably with the term “anisotropic.” Often, a portion of a membrane that has relatively smaller pores (compared to other regions of the membrane) is referred to as a “tight” region. A portion of the membrane that has larger pores is often called an “open” region.

A need exists for membranes with different morphologies for continued improvement for filtering liquid materials.

### SUMMARY

Described as follows are “multi-asymmetric” porous polymeric membranes that can be effective as porous polymeric filter membranes, and methods of preparing and using the described multi-asymmetric porous polymeric membranes.

The described membranes have a “multi-asymmetric” morphology, which means that the membranes include pores that have pore sizes that vary across the thickness of the membrane in a manner that produces at least three regions of different pore sizes. Membranes with multi-asymmetric morphology, as described herein, provide multi-alternating pore size regions to capture particles of different sizes.

The membrane comprises multiple “thickness regions” with different morphologies. A “thickness region” of the membrane is a portion of the membrane that extends in the length and width dimensions of the membrane over a constant portion of the thickness of the membrane. With respect to the present description and claims, a membrane can be considered to include at least three thickness regions of a type identified as an “open pore region” (“open region”) that has relatively large-sized pores, or a “tight pore region” (“tight region”) that has relatively smaller-sized pores. The open regions and the tight regions are present in the membrane in an alternating order along the membrane thickness, e.g., as open-tight-open regions, as tight-open-tight regions, or the like.

The multi-asymmetric membranes can be prepared from sulfone polymers, sometimes referred to as polysulfones, that are capable of being processed by a method of the present description to form a multi-asymmetric membrane, particularly including polysulfones and polyethersulfones.

A multi-asymmetric porous membrane can be prepared by methods according to which a liquid polymer composition is formed into a film, followed by exposing the film to conditions that cause polymer contained in the film to coagulate, including first contacting the film with gaseous water vapor (e.g., air that contains an amount of moisture) to cause initial phase separation within the film, followed by contacting the film with aqueous liquid to cause polymer contained in the film to coagulate and produce a multi-asymmetric polymeric porous membrane.

In one respect, the disclosure relates to a porous polymeric membrane having a membrane thickness and a multi-asymmetric morphology along the thickness. The membrane includes: a membrane average pore size over the membrane thickness, two open regions having average pore sizes and pore size maxima greater than the membrane average pore size, and a tight region having an average pore size and a pore size minimum less than the membrane average pore size, with the tight region being located between the two open regions.

In another respect, the disclosure relates to a method of preparing a porous polymeric membrane having a membrane thickness and a multi-asymmetric morphology along the thickness, the membrane being formed using polyethersulfone or polysulfone. The method includes: forming a liquid polymer composition film, the liquid polymer composition comprising polymer selected from polyethersulfone and polysulfone dissolved in organic solvent that comprises strong solvent and co-solvent; exposing the film to air having at least 20 percent relative humidity to allow moisture in the air to be absorbed by the liquid coating composition and cause the polymer to become more concentrated in a polymer-rich phase and less concentrated in a polymer-lean phase; and after exposing the film to the air, immersing the film in an aqueous bath to cause the polymer to precipitate as a porous polymeric membrane.

### BRIEF DESCRIPTION OF THE FIGURES

FIGS. 1A and 1B show an example of a membrane as described, and data relating to pore size of the membrane.

FIGS. 2A and 2B show an example of a membrane as described, and data relating to pore size of the membrane.

FIGS. 3A and 3B show example steps of methods as described, for producing a multi-asymmetric membrane.

FIG. 4 shows an example of a filter product as described.

### DETAILED DESCRIPTION

The following description relates to “multi-asymmetric” (as described) porous polymeric membranes that can be effective as porous polymeric filter membranes, and also to methods of preparing and using the described multi-asymmetric porous polymeric membranes.

A porous multi-symmetric membrane includes (comprises, consists of, consists essentially of) a porous polymeric membrane body that has a continuous polymeric matrix that defines matrix walls and open pores between the walls, with the pores being multi-asymmetrical along the thickness of the membrane body. The matrix structure is a “continuous,” meaning that the matrix is a single, un-interrupted (other than by the pores) structure made from a single type of polymer throughout the matrix.

The porous polymeric membrane has two opposed, effectively parallel surfaces (or opposed “sides”) that extend in both of a length direction and a width direction, and a thickness that extends in a third direction and is located between the two opposed surfaces. The pores of the porous membrane are located across the thickness of the membrane and allow for a flow of fluid from one side of the membrane, through the thickness of the membrane, to and through the opposite side of the membrane. As fluid flows through the membrane, impurities or contaminants, e.g., particle contaminant, are retained by the membrane and removed from the fluid.

This type of membrane is sometimes referred to as an “open pore” membrane, as compared to “closed pore” membrane. The open pore membrane can be in the form of a thin film or sheet of porous polymeric material that has a relatively uniform thickness over an area (the area having a length and a width), and a continuous open pore structure that includes a polymeric matrix that defines a large number of open “pores,” which are three-dimensional void structures located between solid walls of a continuous matrix structure. The open pores make up interconnected channels or passageways between adjacent pores to allow liquid or gaseous fluid to flow through the thickness of the membrane from one side of the membrane to the other side.

The membrane has a “multi-asymmetric” morphology, which means that the membrane includes pores that have pore sizes that vary across the thickness of the membrane in a manner that produces at least three regions of different pore sizes, with each region being identifiable as an “open pore region” (“open region”) that has relatively large-sized pores, or a “tight pore region” (“tight region”) that has relatively smaller-sized pores, and with the two types of region being present in an alternating order along the membrane thickness, e.g., as open-tight-open regions, as tight-open-tight regions, or the like.

A membrane can be described as having “average pore sizes” at different depth locations. An average pore size at a depth of a membrane is an average of the sizes of pores that are all similarly located at a specific depth location of a membrane, i.e., an average size of pores that are all located at the same distance (“depth”) from a membrane surface. The membrane can be described in terms of an average pore sizes at different individual depths along the thickness of the membrane.

A membrane also has a “membrane average pore size,” which is an average of the sizes of pores of a membrane across the thickness of the membrane, i.e., an average of sizes of pores located at depth locations (distances from a membrane surface) across the entire thickness of the membrane.

Pore size, average pore sizes (across a membrane or at individual depths of the membrane), pore size variation (differences in average pore sizes) across a thickness of a membrane, and the like, can be observed and measured visually, using microscopy, such as with a scanning electron microscopy. Pore size data of a membrane can be collected and analyzed electronically to assess average pore sizes at different depths of a membrane, to compare average pore sizes at different depths within a membrane, and to compare average pore sizes at different depths within a membrane to a membrane average pore size. The analysis can be performed by commercially available software products (e.g., from MatLab, among others) that analyze a matrix of pixels of an SEM image of a membrane using RGB (red, green, blue) coordinates, to identify pores of the membrane (which are black), and then to determine pore sizes and the locations of pores of different sizes as part of the membrane.

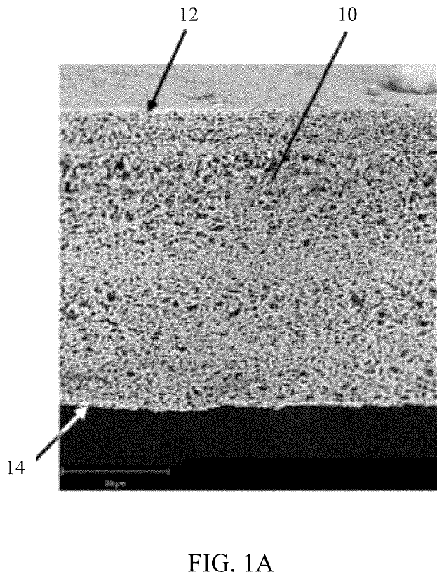

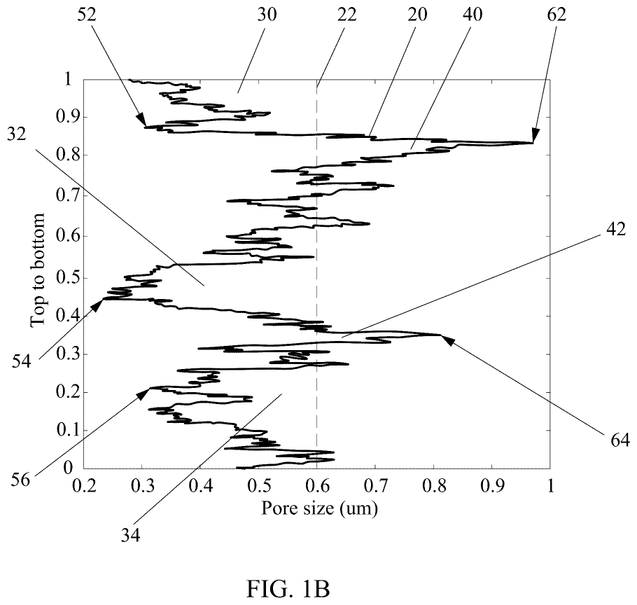

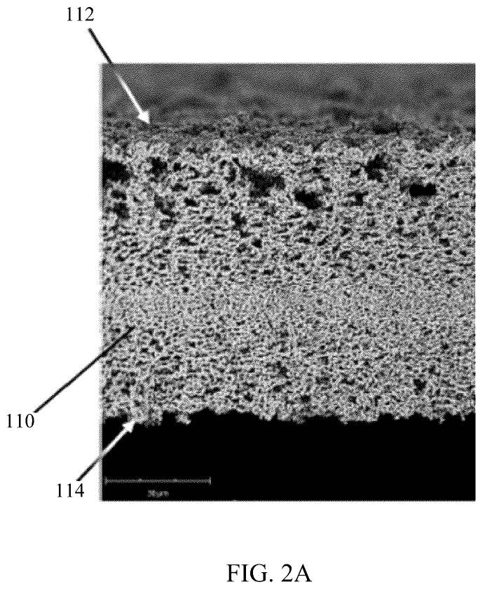

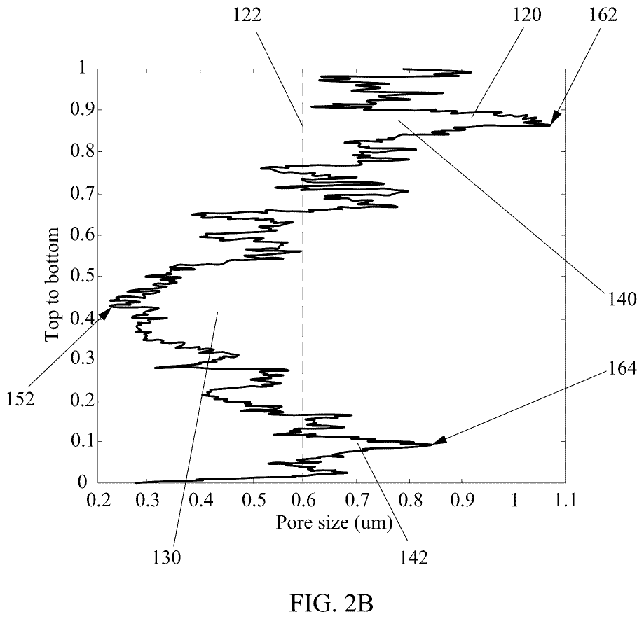

In a useful format, data of pore sizes at different depth locations within a membrane can be analyzed electronically and presented in a form of a graph that plots average pore sizes relative to depth locations of the membrane, measured at different depths of the membrane. See for example FIGS. 1B and 2B. In a graph format that depicts average pore sizes measured at different depths along a thickness of a membrane, the line on the graph that represents the average pore sizes at the respective membrane depths can be referred to as a “pore size function.” Also conveniently, the pore size function of the membrane can be compared to a membrane average pore size, also on the graph. See FIGS. 1B and 2B.

A membrane as described includes at least one region along the thickness of the membrane that is an “open pore region,” or an “open region.” The membrane also includes at least one region along the thickness of the membrane that is a “tight pore region,” or a “tight region. Each tight region will have pore sizes, including a minimum pore size, that are less than the membrane average pore size. Each open region will have a pore sizes, including a maximum pore size, that are greater than the membrane average pore size.

In example membranes, a pore size minimum or a pore size maximum is located at a middle ⅓ of the thickness. Alternately or additionally, a membrane may have at least two pore size minima or at least two pore size maxima at a middle 8/10 of the thickness.

A membrane of the present description, more particularly, includes at least one tight region, at least one open region, and at least one additional region that is either a tight region or an open region. The regions alternate along the membrane thickness between tight regions and open regions.

As an example, a membrane may include two tight regions with an open region between the two tight regions. As another example, a membrane may include two open regions with a tight region between the two open regions. See FIGS. 2A and 2B.

As another example, a membrane may include three tight regions and two open regions in an alternating order: tight-open-tight-open-tight. See FIGS. 1A and 1B. And as yet another example, a membrane may include three open regions and two tight regions in an alternating order: open-tight-open-tight-open.

A tight region is a region of a membrane along a thickness of the membrane that includes pores that have pore sizes (e.g., average pore size at a specific depth) that are less than a membrane average pore size. The pore sizes across a thickness of a tight region can be identified by a pore size function that plots average pore size relative to positions of a membrane in a thickness direction of a membrane, with the pore size function also being compared to a membrane average pore size. Each tight region includes an identifiable low-point on the pore size function over a domain of the tight region between ends of the tight region, which is referred to as a “tight region minimum.” An end of a tight region may be identified as a surface of the membrane or as an intersection of the pore size function with a membrane average pore size.

Similarly, an open region of a membrane is a region along a thickness of a membrane that includes pores that have pore sizes (e.g., average pore sizes) that are greater than a membrane average pore size. Each open region includes an identifiable high-point on the pore size function over a domain of the open region, between ends of the open region, which is referred to as an “open region maximum.” An end of an open region may be identified as a surface of the membrane or as an intersection of the pore size function with a membrane average pore size.

In example membranes, the average pore size of the membrane may be in a sub-micron range, such as from 0.1 micron to 1 microns, e.g., in a range from 0.2 nanometer to 0.9 micron or from 0.3 to 0.8 microns.

The multi-asymmetric porous membrane is considered to be “integral” or “continuous,” meaning that the membrane includes a polymeric matrix that is made of a single type of polymer that forms a single matrix body that is un-interrupted other than by the pores. In a continuous or integral membrane, an entire thickness and both opposed surfaces of the membrane are formed and constructed together as a structurally single and continuous membrane by a single formation step, e.g., by a single step of forming a film (which may be by casting, coating, ore extrusion), followed by coagulation of polymer of the film. When viewed using magnification, the sizes of pore along the depth of the membrane change gradually, including between different thickness regions and between open regions and tight regions; no boundaries between open regions and tight regions are visible as would be visually identifiable in membranes that are “stacked” or multi-layer or co-extruded membranes.

In contrast to integral or continuous porous membranes, other porous membranes may be non-integral or non-continuous. These include membranes, sometimes referred to as multi-layer membranes or “stacked” membranes that are prepared by combining together two separate (separately-prepared) membrane layers, in series, each of which may have a different morphology or chemical composition. These also include porous membranes that are formed using two different polymer compositions by co-extruding two different polymer compositions to form a single “co-extruded” membrane from two or more different polymer materials. These types of stacked multi-layer assemblies and co-extruded membrane structures are not considered to be “integral” or “continuous” membranes.

Examples of useful multi-asymmetric membranes as described may be used alone in the absence of another membrane or layer, and without any coating applied to the multi-asymmetric membrane. It is also possible, however, to combine a continuous or integral multi-asymmetric membrane of the present description with a layer of another membrane or with a support structure, etc., to form a multi-layer membrane structure that contains the multi-asymmetric membrane as one membrane layer of the multi-layer structure. Alternately or additionally, a coating of a separate material may be applied to a multi-asymmetric membrane of the present description to form a composite membrane that includes the continuous multi-asymmetric membrane with a coating applied to one or more surfaces of the multi-asymmetric membrane.

A multi-asymmetric membrane as described can be prepared from sulfone polymers, sometimes referred to as polysulfones, that are capable of being processed by a method of the present description to form a multi-asymmetric membrane.

The family of polysulfone polymers includes thermoplastic polymers that contain the common structural unit “diphenyl sulfone.” Examples polysulfones include polysulfone (“PS” or “PSU”) polymers, polyaryl sulfone polymers, polyether sulfone (“PES”) polymers, and polyphenyl sulfone polymers. Membranes of the present description can be prepared in particular to include high amounts of (e.g., comprise, consist of, or consist essentially or) either polysulfone polymer or polyether sulfone polymer, or a combination of these two types of polysulfone polymers. Example multi-asymmetric membranes of the present description can be made from polymer that includes (e.g., comprises, consists of, or consists essentially of) at least 80, 90, 95, or 99 percent polyethersulfone, polysulfone, or a mixture of these two polymers.

Polysulfone polymers contain (comprise, consist of, or consist essentially of) a high amount (at least 80, 90, 95, or 99 percent) of polysulfone repeating units:

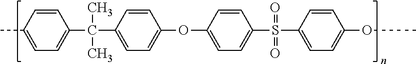

Polyethersulfone polymer contain (comprise, consist of, or consist essentially of) a high amount (at least 80, 90, 95, or 99 percent) of polyethersulfone repeating units:

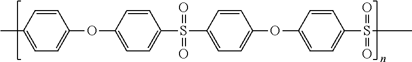

Commercially available polyethersulfone polymers available include those sold under the trade names VERADEL® from Solvay Specialty Polymers, ULTRASON® E from BASF, and as RADEL®-A from AMOCO Polymers, among others. Exemplary polysulfones includes polymers that are commercially available from Solvay Specialty Polymers (Udel® PSU polysulfone), BASF (Ultrason® PSU), and PolyOne corporation (Edgetek® PSU).

A polyethersulfone or polysulfone polymer for use in a method and membrane described herein can be of any effective molecular weight. For example, a polyethersulfone or polysulfone can have an average molecular weight or weight-average molecular weight in the range of about 1,000 grams per mole to about 1,000,000 grams per mole, e.g., from 50,000 to 900,000 or from 100,000 to 800,000 grams per mole.

A multi-asymmetric membrane of the present description can have any useful thickness, such as a thickness in a range from 50 to 300 microns, for example in a range from 25 or 40 microns, up to 250 or 200 microns.

Referring to FIG. 1A, a cross-section of example porous membrane 10 is shown, having a surface 12, a second surface 14, and a thickness between these two surfaces.

FIG. 1B is a plot that shows average pore size of pores at locations along the depth of membrane 10, between two surfaces 12 and 14 (surface 14 corresponds to a depth of 0 on the y-axis, and surface 12 corresponds to a depth of 1). The average pore size at each location along the depth of membrane 10 is shown at pore size function 20 (the jagged line). Also shown at FIG. 1B is membrane average pore size 22 (the straight dashed line), which is a pore size that is calculated as an average size of all pores located on a line that extends in the thickness direction of membrane 10, between surfaces 12 and 14. The average size of the pores of membrane 10 is approximately 0.5554 microns.

FIG. 1B shows that membrane 10 includes three tight regions and two open regions, i.e., has alternating tight and open regions in the order: “tight-open-tight-open-tight.” Tight regions are shown at FIG. 1B as regions 30, 32, and 34, with pore sizes of membrane 10 being measured as less than membrane average pore size 22. Open regions are shown at FIG. 1B as regions 40 and 42, with pore sizes of membrane 10 being measured as greater than membrane average pore size 22. Membrane 10 also has three pore size minima, shown as minima 52, 54, and 56 of pore size function 20, and two pore size maxima, 62 and 64.

Referring to FIG. 2A, a cross-section of example porous membrane 110 is shown, having a surface 112, a second surface 114, and a thickness between these two surfaces.

FIG. 2B is a plot that shows average pore size of pores at locations along the depth of membrane 110, between two surfaces 112 and 114. The average pore size at each location along the depth of membrane 110 is shown at pore size function 120. Also shown at FIG. 2B is membrane average pore size 122, which is a pore size that is calculated as an average size of all pores located on a line that extends in the thickness direction of membrane 110 between surfaces 112 and 114.

FIG. 2B shows that membrane 110 includes two open regions and one tight region, i.e., has alternating tight and open regions in the order: “open-tight-open.” The tight region is shown at FIG. 2B as region 130, with pore sizes of membrane 110 being measured as less than membrane average pore size 122. Open regions are shown at FIG. 2B as regions 140 and 142, with pore sizes of membrane 110 being measured as greater than membrane average pore size 122. Membrane 110 also has one pore size minimum, shown as minima 152 of pore size function 120, and two pore size maxima, 162 and 164. The average size of the pores of membrane 110 is approximately 0.487 microns.

To produce the data of FIGS. 1B and 2B, the images of FIGS. 1A and 2A were analyzed with the following procedures. First, MatLab software was used to read each SEM (scanning electron microscope) image into RGB (red, green, blue) coordinates. Each pixel contains an RGB value that shows its color. Then, the program scans the SEM RGB matrix to identify the black pixels, which represents the membrane pores. That the cropped SEM image can be pre-processed by MatLab function imadjust to enhance the contrast of the image.

The product includes the pixel coordinates that represent the pores (black pixels). The pixels can be classified into groups where each group represents an individual pore. This is achieved by checking if the pixels are next to each other. If yes, then they belong to the same pore. The program identifies the number of pixels in each pore to calculate pore size. For example, if a pore of irregular shape contains 500 black pixels, then its equivalent pore diameter is d=((S/pi)\hat{ }0.5)*2=((500/3.14)\hat{ }0.5)*2 =25 pixels. From the known scale of the image is calculated the unit length of each pixel, and the pore sizes. The data of the pores is used to generate the pore size distribution along the y-axis. This is achieved by examining each row of the pixels. MatLab finds the position of the black pixel, and see which pore it belongs to. Then it records the pore size.

A multi-asymmetric porous membrane can be prepared by novel and inventive methods according to which a liquid polymer composition is formed into a film, followed by exposing the film to conditions that cause polymer contained in the film to coagulate, including first contacting the film with gaseous water vapor (e.g., air that contains an amount of moisture) to cause initial phase separation within the film, followed by contacting the film with aqueous liquid to cause polymer contained in the film to coagulate and produce a multi-asymmetric polymeric porous membrane.

As background, different varieties of porous membranes can be prepared by forming a polymer-containing liquid film, followed by causing polymer contained in the film to coagulate. Various different techniques are known for causing (inducing) the polymer to coagulate. One technique, referred to as “nonsolvent-induced phase separation” (NIPS), exposes the film to a “non-solvent,” which causes polymer in the film to coagulate. A different technique, referred to as “thermally-induced phase separation” (TIPS), uses a change in temperature of the liquid film to cause polymer in the film to coagulate.

Methods described herein can involve nonsolvent-induced phase separation as opposed to thermally-induced phase separation, and useful methods do not require and can specifically exclude exposing the liquid polymer composition to a temperature change to induce phase separation or polymer coagulation. According to methods of the present description, polymer that is contained in a film of liquid polymer composition may be coagulated to form a multi-asymmetric polymeric porous membrane by steps that do not cause or allow the temperature of the liquid polymer composition to vary significantly from ambient temperature. In example methods, a liquid polymer composition can be held at a temperature that is in a range from 20 to 32 degrees Celsius as the liquid polymer composition is formed into a film, and as the film is processed to cause polymer in the liquid polymer composition to coagulate to form a multi-asymmetric polymeric porous membrane. The temperature of the liquid coating composition, before and during steps of forming a film and causing polymer in the film to coagulate, can be in a range from 20 to 32 degrees Celsius, e.g., in a range from 20 to 30 or 20 to 25 degrees Celsius.

By conventional nonsolvent-induced phase separation (NIPS), liquid polymer composition that contains polymer that is dissolved or suspended in a liquid solvent is formed into a film. The film may be formed by an useful method, such as by extruding, coating, or otherwise applying the liquid polymer composition on a supporting surface, such as a surface of a roller, a moving belt, or the like. The film is then allowed to contact “nonsolvent,” which induces phase separation of the ingredients of the liquid polymer composition.

According to certain specific techniques, referred to as “immersion casting,” the cast film is immersed in a coagulation bath that contains the nonsolvent to cause phase separation within the film. One common nonsolvent is water, but aqueous solutions or pure organic solvents such as ethanol, isopropanol, or butanol can be also used as a nonsolvent in a coagulation bath. The film, during immersion in the nonsolvent, separates into two phases: one polymer-rich phase that forms the continuous membrane matrix, and one solvent-rich (polymer-lean) phase that forms the dis-continuous pores of the membrane.

According to the present description, methods of inducing coagulation in a film formed from liquid polymer composition include an immersion step, i.e., a step of immersing the film into an aqueous bath, but the immersion step is performed after a step of exposing the film to air that contains an amount of moisture. After the film is formed (by any useful method), the film is exposed to air that contains an amount of moisture, i.e., humid air, and that is at a temperature in an ambient temperature range. The amount of moisture in the air can preferably be in a range from 20 to 75 percent relative humidity (e.g., from 20 to 50 percent relative humidity) and the air can be at a temperature in a range from 20 to 30 degrees Celsius, e.g., from 20 to 25 degrees Celsius.

The air contains moisture, and the moisture in the air is absorbed by the film as water. The water that is absorbed by the liquid coating composition causes polymer that is dissolved or suspended in solvent of the liquid coating composition to become more concentrated in a polymer-rich phase of the coating composition, and less concentrated in a polymer-lean phase of the coating composition.

A step of exposing a film of the liquid coating composition to air that contains moisture, before an immersion step that immerses the film in an aqueous bath, can be performed for any useful amount of time. A desirable amount of time may be an amount of time that is effective to cause a desired effect on the liquid coating composition. A desired effect may be to allow water in the air to be absorbed by the liquid coating composition e.g., for an amount of time that will produce a desired amount of polymer becoming concentrated in the polymer-rich phase. Examples of useful amounts of time for exposing the film to air that contains moisture can be at least 30 seconds, e.g., from 30 seconds to 5 minutes, or from 30 seconds to 4, 3, or 2 minutes.

In a specific method, liquid polymer composition contains dissolved polymer (polysulfone, polyethersulfone, or a combination of these), in a combination of solvents that includes a strong solvent and a co-solvent. A “strong solvent” is a solvent that alone is able to completely dissolve an amount of polymer of a liquid polymer composition. A co-solvent is a solvent that by itself is not able to completely dissolve an amount of polymer of a liquid polymer composition, but that is used in combination with a strong solvent to affect (improve) solubility properties of the strong solvent in a liquid polymer composition.

Examples of strong solvents include n-methyl pyrrolidone, dimethylformamide (DMF), dimethylacetate (DMAC), and dimethylsulfoxide (DMSO). Examples of cosolvents that may be useful with these or other strong solvents include polyols, e.g., a glycol such as diethylene glycol (DEG), triethylene glycol (TEG), etc.

The amount of polymer in the liquid polymer composition can be any amount that is useful to produce a multi-asymmetrical membrane as described, by a method as described. Example concentrations of polymer in a liquid polymer composition can be in a range from 5 to 20 weight percent, e.g., a concentration in a range from 8 to 15 weight percent, based on total weight liquid polymer composition.

The balance of the liquid polymer composition, i.e., the liquid polymer composition that is not polymer, may be solvent; e.g., the liquid coating composition may contain solvent, meaning a total amount of two or more different types of solvents, in an amount in a range from a range from 80 to 95 weight percent solvent (total), e.g., in an amount in a range from 85 to 92 weight percent solvent (total), based on total weight liquid polymer composition. In some embodiments the liquid polymer composition may be 5 to 20 weight percent polymer, 10 to 40 percent strong solvent, and 30 to 80 weight percent co-solvent.

In certain an example liquid polymer compositions, a composition can contain a strong solvent, e.g., n-methyl pyrrolidone, in an amount in a range from 10 to 40 weight percent, e.g., from 15 to 35 weight percent, based on total weight liquid polymer composition.

In certain example liquid polymer compositions, a composition can contain cosolvent, such as a polyol (e.g., DEG, PEG) in an amount in a range from 30 to 80 weight percent, e.g., from 40 to 70 weight percent, based on total weight liquid polymer composition.

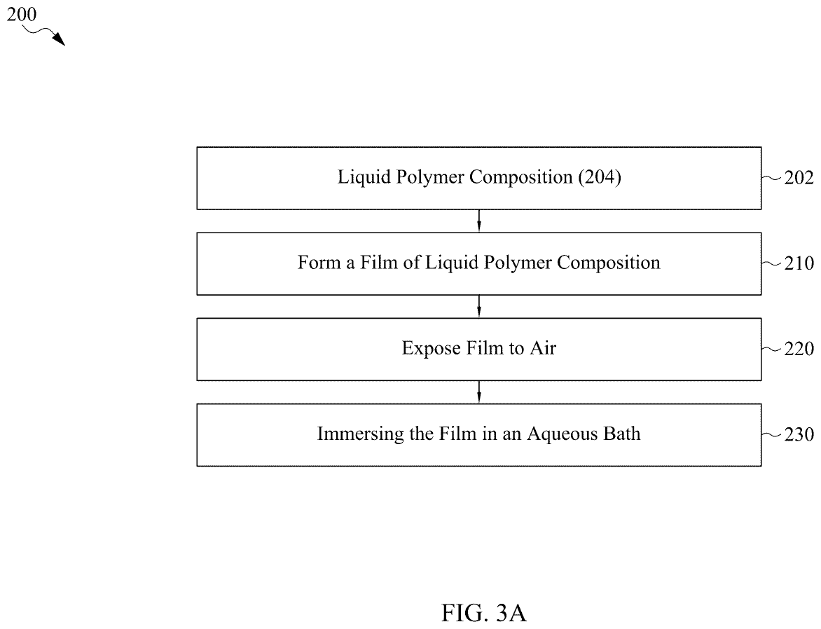

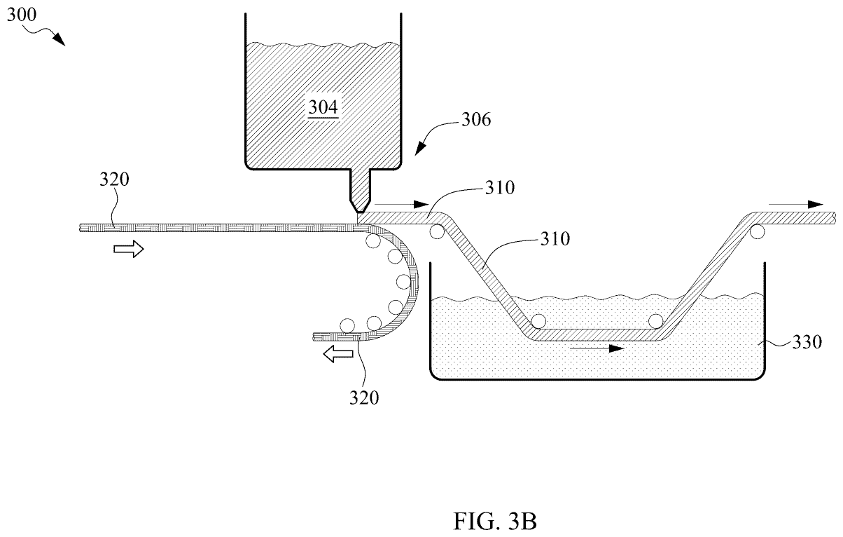

Referring to FIG. 3A, a general method 200 useful for forming the multi-asymmetric membrane may be performed using a series of steps that include: forming or otherwise providing (202) polymer-containing liquid (204) that includes polymer for preparing a porous polymeric membrane dissolved or suspended in solvent; forming (210) a film from the liquid; exposing (220) the film to air that contains moisture; and immersing (230) the film in an aqueous bath to form a multi-asymmetric coagulated porous polymeric membrane. A useful method may also include drying or otherwise further processing the formed porous polymeric membrane.

To form (202) the liquid polymer composition (204), polymer can be combined with solvent (e.g., suspended or dissolved in the solvent) to form a polymer-containing liquid that contains polymer in a non-coagulated or partially coagulated form (referred to herein as a “liquid polymer composition” or a “polymer-containing liquid”) that can be formed into a film. The step of forming the liquid polymer composition (204) can be performed with the liquid composition (204) being held at or otherwise having a temperature in an ambient range, e.g., from 20 to 30 degrees Celsius, or from 20 to 25 degrees Celsius.

The liquid polymer composition can be formed into a film (210) by any useful method, such as by an extrusion method (using a die), a casting method, a coating method, or the like, effective to form a thin film of the liquid coating composition. In an example film-forming step, liquid coating composition can be applied onto a stationary or moving solid surface such as glass or metal, to form a film. According to an example of a continuous process, a film may be formed using a die, a coater, or any other type of extrusion or film-forming device, and the film may be applied to a moving belt, a roller surface, or another moving surface, in a continuous manner.

The step of forming (210) a film from the liquid polymer composition (204) can be performed with the liquid composition (204) being held at or otherwise having a temperature in an ambient range, e.g., from 20 to 30 degrees Celsius, or from 20 to 25 degrees Celsius.

After forming the film, the film is exposed (220) to air that contains an amount of moisture (humidity). The moisture in the air becomes absorbed by the liquid coating composition of the film. The moisture, i.e., water, acts as antisolvent within the liquid coating composition and causes the polymer in the liquid coating composition to form a polymer-lean phase, and a polymer-rich phase. The water absorbed from the air causes the concentration of dissolved polymer in the film to become higher (the polymer is more concentrated) in a polymer-rich phase, and to become lower (the polymer is less concentrated) in a polymer-lean phase.

Following the step of exposing (220) the film to air, which contains moisture, the film is immersed (230) in an aqueous bath (i.e., a “coagulation bath”). The aqueous bath can be a liquid bath that contains mostly water, e.g., at least 70, 80, 90, or 95 weight percent water, with optional organic solvent. The aqueous bath can be held at or can otherwise have a temperature in an ambient range, e.g., from 20 to 30 degrees Celsius, or from 20 to 25 degrees Celsius.

Referring to FIG. 3B, a more specific example of method 300 is shown, for producing a multi-asymmetric membrane steps that include. As shown, liquid polymer composition 304 is delivered to a coating or extruding device 306. Device 306 is used to deliver liquid polymer composition 304 as a 310 onto surface. Device 306 may form film 310 by any useful method, such as by an extrusion method (using a die), a casting method, a coating method, or the like. As illustrated, liquid coating composition 304 is applied to a moving surface such as moving belt 320. During the step of applying film 310 to moving belt 320, the liquid coating composition 304 and the surface to which the film is applied (belt 320) are at a temperature in an ambient range, e.g., from 20 to 30 degrees Celsius, or from 20 to 25 degrees Celsius.

After forming film 320, the film is exposed to air that contains an amount of moisture (humidity). The moisture in the air becomes absorbed by the liquid coating composition of the film. The moisture, i.e., water, acts as antisolvent within the liquid coating composition and causes the polymer in the liquid coating composition to form a polymer-lean phase, and a polymer-rich phase. Following the step of exposing film 310 to air, which contains moisture, the film is immersed in aqueous bath 330 (i.e., a “coagulation bath”), which has a temperature in an ambient range, e.g., from 20 to 30 degrees Celsius, or from 20 to 25 degrees Celsius.

According to one example, multi-asymmetric porous polymer membrane 10 of FIG. 1A was prepared according to a method as described by forming a film of liquid polymer composition on a solid surface. The liquid polymer composition contained approximately 27 weight percent n-methyl pyrrolidone, 63 weight percent triethylene glycol, and 10 weight percent polyethylene sulfone. The liquid coating composition and the film were at ambient temperature to form the film. The film, on the surface, was then exposed to ambient air having a relative humidity of 50 percent, for 45 seconds. The film was then immersed in water at 20 degrees Celsius. The resultant porous polymer membrane 10 is shown at FIG. 1A.

Membrane 10 was tested and found to have a bubble point of 67.9 pounds per square inch (psi), and a flow of 35704 liters per square meter per hour per bar (LMHB). The flow rate is measured by measuring the total volume of DI water that passes through a membrane with a surface area of 13.8 cm² at 14.2 psi, and at a temperature 21 degrees Celsius, over a one minute period of time. The bubble point method is based on the premise that, for a particular fluid and pore size with constant wetting, the pressure needed to force an air bubble through the pore is in inverse proportion to the size of the pore. A higher bubble point value relates to small pore sizes. To determine the bubble point of a porous material a sample of the porous material is immersed in and wetted with DI water at a temperature of 20-25 degrees Celsius (e.g., 22 degrees Celsius). A gas pressure is applied to one side of the sample by using compressed air and the gas pressure is gradually increased. The minimum pressure at which the gas flows through the sample is called the bubble point.

According to another example, multi-asymmetric porous polymer membrane 110 of FIG. 2A was prepared according to a method as described by forming a film of liquid polymer composition on a solid surface. The liquid polymer composition contained approximately 27 weight percent n-methyl pyrrolidone, 63 weight percent triethylene glycol, and 10 weight percent polyethylene sulfone. The liquid coating composition and the film were at ambient temperature to form the film. The film, on the surface, was then exposed to ambient air having a relative humidity of 50 percent, for 60 seconds. The film was then immersed in water at 20 degrees Celsius. The resultant porous polymer membrane 110 is shown at FIG. 2A. Membrane 110 was tested and found to have a bubble point of 48.9 psi and a flow rate of 90149 LMHB.

In some embodiments, the membranes described herein have a bubble point of at least 40 psi, at least 45 psi, at least 50 psi, at least 55 psi, at least 60 psi, at least 65 psi, at least 70 psi, and all ranges and subranges therebetween and/or flow rate of at least 30,000 LMHB, at least 35,000 LMHB, at least 40,000 LMHB, at least 45,000 LMHB, at least 50,000 LMHB, at least 55,000 LMHB, at least 60,000 LMHB, at least 65,000 LMHB, at least 70,000 LMHB, at least 75,000 LMHB, at least 80,000 LMHB, at least 85,000 LMHB, at least 90,000 LMHB, at least 95,000 LMHB, at least 100,000 LMHB and all ranges and subranges therebetween.

A membrane as described herein, or a filter or filter component that contains the filter membrane, can be useful in a method of filtering a liquid material to purify or otherwise remove unwanted particles from the liquid chemical material. Generally, the liquid chemical may be any of various useful commercial materials, and may be a liquid chemical that is useful in any of a variety of different industrial, commercial, or laboratory applications; or for uses in the medical, pharmaceutical, life science, and food industries.

The membrane can be contained within a larger filter structure such as a filter or a filter cartridge that is used in a filtering system. The filtering system will place the filter membrane, e.g., as part of a filter or filter cartridge, in a flow path of a liquid to cause the liquid to flow through the filter membrane so that the filter membrane is able to remove impurities and contaminants, e.g., in the form of particles on a micron or sub-micron size range, from the liquid. The structure of a filter or filter cartridge may include one or more of various additional materials and structures that support the porous filter membrane within the filter to cause fluid to flow from a filter inlet, through the filter membrane, and thorough a filter outlet, thereby passing through the filter membrane when passing through the filter. The filter membrane supported by the filter structure can be in any useful shape, e.g., a pleated cylinder, cylindrical pads, one or more non-pleated (flat) cylindrical sheets, a pleated sheet, among others.

One example of a filter structure that includes a filter membrane in the form of a pleated cylinder can be prepared to include the following component parts, any of which may be included in a filter construction but may not be required: a rigid or semi-rigid typically cylindrical core that supports a pleated cylindrical membrane at an interior channel of the pleated cylindrical filter membrane; a rigid or semi-rigid cage that supports or surrounds an exterior of the pleated cylindrical filter membrane at an exterior of the filter membrane; optional end pieces or “pucks” that are situated at each of the two opposed ends of the pleated cylindrical filter membrane; and a filter housing that includes an inlet and an outlet, with the membrane being supported at a location between the inlet and outlet that causes liquid to flow through the membrane to pass from the inlet to the outlet. The filter housing can be of any useful and desired size, shape, and materials, and can preferably be made of suitable polymeric materials.

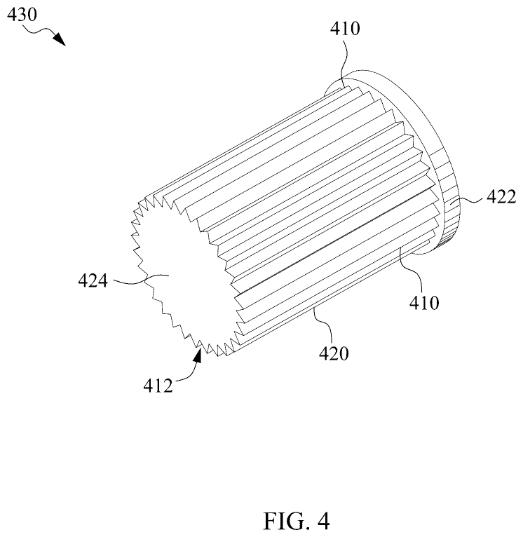

As one example, FIG. 4 shows filter component 430, which is a product of pleated cylindrical component 410 and end piece 422, with other optional components. Cylindrical component 410 includes a porous membrane 412, as described herein, and contains folds or pleats 420, i.e., is “pleated.” End piece 422 is attached (e.g., “potted”) to one end of cylindrical filter component 410. End piece 422 can preferably be made of a melt-processable polymeric material. A core (not shown) can be placed at the interior opening or “channel”) 424 of pleated cylindrical component 410, and a cage (not shown) can be placed about the exterior of pleated cylindrical component 410. A second end piece (not shown) can be attached (“potted”) to the second end of pleated cylindrical component 420. The resultant pleated cylindrical component 420 with two opposed potted ends and optional core and cage can then be placed into a filter housing that includes an inlet and an outlet and that is configured so that fluid that enters the inlet must necessarily pass through membrane 412 before exiting the filter at the outlet.

The filter housing can be of any useful and desired size, shape, and materials, and can preferably be a fluorinated or non-fluorinated polymer such as nylon, polyethylene, or fluorinated polymer such as a poly (tetrafluoroethylene-co-perfluoro(alkylvinylether)), TEFLON® perfluoroalkoxyalkane (PFA), perfluoromethylalkoxy (MFA), or another suitable fluoropolymer (e.g., perfluoropolymer).

In a first aspect, a porous polymeric membrane having a membrane thickness and a multi-asymmetric morphology along the thickness comprises a membrane average pore size over the membrane thickness; two open regions having average pore sizes and pore size maxima greater than the membrane average pore size; and a tight region having an average pore size and a pore size minimum less than the membrane average pore size, with the tight region being located between the two open regions.

In a second aspect according to the first aspect, wherein the membrane has a pore size profile along the thickness comprising: open region-tight region-open region.

In a third aspect according to the first aspect, wherein the membrane has a pore size profile along the thickness comprising: open region-tight region-open region-tight region-open region.

In a fourth aspect according to any of the preceding aspects, the membrane has a bubble point of greater than 40 psi.

In a fifth aspect according to any of the preceding aspects, the membrane has a flow rate of at least 30,000 LMHB.

In a sixth aspect according to any of the preceding aspects, the membrane has a membrane average pore size in a range from 0.2 to 1 micron.

In a seventh aspect according to any of the preceding aspects, the membrane comprises polyethersulfone.

In an eighth aspect according to any of the preceding aspects, the membrane comprises polysulfone.

In a ninth aspect, a filter cartridge comprises the membrane of any preceding aspect.

In a tenth aspect, a method of preparing a porous polymeric membrane having a membrane thickness and a multi-asymmetric morphology along the thickness comprises: forming a liquid polymer composition film, the liquid polymer composition comprising polymer selected from the group consisting of polyethersulfone and polysulfone dissolved in organic solvent that comprises strong solvent and co-solvent; exposing the film to air having at least 20 percent relative humidity to allow moisture in the air to be absorbed by the liquid coating composition and cause the polymer to become more concentrated in a polymer-rich phase and less concentrated in a polymer-lean phase; and after exposing the film to the air, immersing the film in an aqueous bath to cause the polymer to precipitate as a porous polymeric membrane.

In an eleventh aspect according to the tenth aspect, the film is exposed to air having at least 20 percent relative humidity for at least 30 seconds.

In a twelfth aspect according to the tenth or eleventh aspect, the liquid polymer composition film is formed by casting the liquid polymer composition as a film onto a surface having a temperature in a range from 20 to 30 degrees Celsius.

In a thirteenth aspect according to any of the tenth through twelfth aspects, the air has a temperature in a range from 20 to 30 degrees Celsius.

In a fourteenth aspect according to any of the tenth through thirteenth aspects, the liquid polymer composition has a temperature in a range from 20 to 30 degrees Celsius.

In a fifteenth aspect according to any of the tenth through fourteenth aspects, the aqueous bath has a temperature in a range from 20 to 30 degrees Celsius.

In a sixteenth aspect according to any of the tenth through fifteenth aspects, the strong solvent is n-methyl pyrrolidone.

In a seventeenth aspect according to any of the tenth through sixteenth aspects, the cosolvent is a polyol.

In an eighteenth aspect according to any of the tenth through seventeenth aspects, the cosolvent comprises diethylene glycol, triethylene glycol, or a combination thereof.

In a nineteenth aspect according to any of the tenth through eighteenth aspects, the coating composition comprises: from 5 to 20 weight percent polymer, from 10 to 40 weight percent strong solvent, and from 30 to 80 weight percent co-solvent.

In a twentieth aspect according to any of the tenth through nineteenth aspects, the porous membrane comprises: a membrane average pore size over the membrane thickness; two open regions having average pore sizes and pore size maxima greater than the membrane average pore size; and a tight region having an average pore size and a pore size minimum less than the membrane average pore size, with the tight region being located between the two open regions.

1. A porous polymeric membrane having a membrane thickness and a multi-asymmetric morphology along the thickness, the membrane comprising:
a membrane average pore size over the membrane thickness;
two open regions having average pore sizes and pore size maxima greater than the membrane average pore size; and
a tight region having an average pore size and a pore size minimum less than the membrane average pore size, with the tight region being located between the two open regions.

2. The porous polymeric membrane of claim 1 having a pore size profile along the thickness comprising: open region-tight region-open region.

3. The porous polymeric membrane of claim 1 having a pore size profile along the thickness comprising: open region-tight region-open region-tight region-open region.

4. The porous polymeric membrane of claim 1, wherein the membrane has a bubble point of greater than 40 psi.

5. The porous polymeric membrane of claim 1, wherein the membrane has a flow rate of at least 30,000 LMHB.

6. The porous polymeric membrane of claim 1, wherein the membrane has a membrane average pore size in a range from 0.2 to 1 micron.

7. The porous polymeric membrane of claim 1, wherein the membrane comprises polyethersulfone.

8. The porous polymeric membrane of claim 1, wherein the membrane comprises polysulfone.

9. A filter cartridge comprising the porous polymeric membrane of claim 1.

10. A method of preparing a porous polymeric membrane having a membrane thickness and a multi-asymmetric morphology along the membrane thickness, the method comprising:
forming a liquid polymer composition film, the liquid polymer composition comprising polymer selected from the group consisting of polyethersulfone and polysulfone dissolved in organic solvent that comprises strong solvent and co-solvent;
exposing the liquid polymer composition film to air having at least 20 percent relative humidity to allow moisture in the air to be absorbed by the liquid polymer composition and cause the polymer to become more concentrated in a polymer-rich phase and less concentrated in a polymer-lean phase; and
after exposing the liquid polymer composition film to the air, immersing the liquid polymer composition film in an aqueous bath to cause the polymer to precipitate as a porous polymeric membrane.

11. The method of claim 10, wherein the liquid polymer composition film is exposed to air having at least 20 percent relative humidity for at least 30 seconds.

12. The method of claim 10, wherein the liquid polymer composition film is formed by casting the liquid polymer composition as a film onto a surface having a temperature in a range from 20 to 30 degrees Celsius.

13. The method of claim 10, wherein the air has a temperature in a range from 20 to 30 degrees Celsius.

14. The method of claim 10, wherein the liquid polymer composition has a temperature in a range from 20 to 30 degrees Celsius.

15. The method of claim 10, wherein the aqueous bath has a temperature in a range from 20 to 30 degrees Celsius.

16. The method of claim 10, wherein the strong solvent is n-methyl pyrrolidone.

17. The method of claim 10, wherein the cosolvent is a polyol.

18. The method of claim 10, wherein the cosolvent comprises diethylene glycol, triethylene glycol, or a combination thereof.

19. The method of claim 10, wherein the liquid polymer composition comprises:
from 5 to 20 weight percent polymer,
from 10 to 40 weight percent strong solvent, and
from 30 to 80 weight percent co-solvent.

20. The method of claim 10, wherein the porous polymeric membrane comprises:
a membrane average pore size over the membrane thickness;
two open regions having average pore sizes and pore size maxima greater than the membrane average pore size; and
a tight region having an average pore size and a pore size minimum less than the membrane average pore size, with the tight region being located between the two open regions.
